(19) United States
(12) Patent Application Publication
(10) Pub. No.: US 2010/0167664 A1
(43) Pub. Date: Jul. 1, 2010

(54) Apparatus and Method for Providing Antenna Beamforming

(75) Inventor: Istvan Szini, Grayslake, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/389,165

(22) Filed: Feb. 19, 2009

Related U.S. Application Data
(60) Provisional application No. 61/142,097, filed on Dec. 31, 2008.

(51) Int. Cl. H04B 1/38; H04B 1/02

(52) U.S. Cl. 455/73; 455/101

(57) ABSTRACT

The present invention provides a device and a method in a device having a plurality of antennas for providing beamforming. The method includes reading one or more sensors, which are adapted to detect at least one of user interaction with the device or device proximity to other objects, and present device geometry. A phase adjustment is then computed in a controller for forming a radiated beam, based upon the readings of the one or more sensors, that enhances the received energy at an intended destination. The computed phase adjustment is then applied to one or more phase adjustment circuits, respectively coupled to at least some of the plurality of antennas. A signal is then transmitted by a transmitter to the intended destination via at least some of the plurality of antennas.

### FIELD OF THE INVENTION

The present invention relates generally to a multiple antenna system for transmitting a signal, and more particularly, to using the multiple antennas to steer the radiated energy jointly produced by the multiple antennas.

### BACKGROUND OF THE INVENTION

There is a general trend in connection with electronic products for features and performance to become better over time. In some instances, higher performance is driven by more stringent regulations. In other instances, the increase in performance is the result of natural competition between products in the market place, which are continually trying to boost performance to attract new buyers, and/or a larger percentage of the buyers. This results in electronic manufactures which generally are continually looking for ways to boost performance.

In the case of portable wireless communication devices, battery life is one such factor that has some traction with the consumer in influencing purchasing decisions. One way to increase battery life is to increase the capacity of the battery in terms of its ability to store a charge. An alternative approach involves changes to make better and/or more efficient use of the already existing available power.

One aspect of wireless communication devices, which consumes a fair amount of power includes the energy involved in transmitting a signal to an intended recipient. In many cases the wireless communication device is communicating with a single individual located in a particular direction relative to the device. Nevertheless, many wireless communication devices continue to broadcast wireless signals in an omni-directional pattern. Much of this radiated energy goes in a direction other than towards the intended recipient and does not meaningfully contribute to the signal quality received by the noted recipient. Furthermore, much of the energy which is directed away from the intended recipient in turn contributes to the noise experienced by other wireless communication devices.

Still further, in at least some instances radiated energy might be propagated in a direction where it is likely to be impacted by nearby objects which can obstruct the portion of the signal propagating in that particular direction. This results in a loss of radiated energy, which is precluded from having being received as intended, even though it might have been appropriately directed toward the intended recipient.

The present inventor has recognized that it would be beneficial if nearby objects could be detected which might otherwise interfere with the propagation of a wireless communication signal, and that the energy be directed in a direction where the energy is unlikely to be otherwise impeded and more likely to be directed in a direction consistent with the location of the intended recipient, thereby enabling a greater share of the energy to be directed in a direction where it is more likely to be received.

### SUMMARY OF THE INVENTION

The present invention provides a method in a device having a plurality of antennas for providing beamforming. The method includes reading one or more sensors, which are adapted to detect at least one of user interaction with the device or device proximity to other objects, and present device geometry. A phase adjustment is then computed in a controller for forming a radiated beam, based upon the readings of the one or more sensors, that enhances the received energy at an intended destination. The computed phase adjustment is then applied to one or more phase adjustment circuits, respectively coupled to at least some of the plurality of antennas. A signal is then transmitted by a transmitter to the intended destination via at least some of the plurality of antennas.

In at least one embodiment, the method further includes receiving a signal from the intended destination, and computing the direction of arrival of the signal, wherein the direction of arrival is used by the controller in computing a phase adjustment.

The present invention further provides a wireless communication device. The wireless communication device includes a transmitter for producing a signal to be transmitted, and a plurality of antennas coupled to the transmitter for receiving the signal to be transmitted and converting the signal into radiated energy. The wireless communication device further includes one or more sensors adapted for detecting at least one of a user interaction with the device or device proximity to other objects, and present device geometry. A controller coupled to the plurality of sensors receives the detected output of the sensors. The wireless communication device further includes one or more phase shift circuits coupled between at least one of the antennas and the transmitter. The phase shift circuit adjusts the phase of the signal delivered to the corresponding antenna from the transmitter, where the controller includes a phase adjustment module that is adapted to produce a control signal based upon the received output of the sensors, and control the amount of phase shift applied by the one or more phase shift circuits.

In at least one embodiment, the wireless communication device further comprises a receiver, which is adapted for detecting a radiated signal originating from outside of the device and for producing a received signal, wherein detected characteristics of the received signal can be used to identify the direction of an intended destination of signals to be transmitted by the wireless communication device.

These and other objects, features, and advantages of this invention are evident from the following description of one or more preferred embodiments of this invention, with reference to the accompanying drawings.

### BRIEF DESCRIPTION OF THE DRAWINGS

FIG. 1 is a block diagram of wireless communication device for providing antenna beamforming, in connection with transmitting a signal, in accordance with at least one embodiment of the present invention;

FIG. 2 is a side plan view of a wireless communication device illustrating exemplary positioning of a set of sensors intended to detect the present geometry of a device having a multiple part housing adapted to move relative to one another;

FIG. 3 is a further side plan view of a wireless communication device illustrating exemplary positioning of a set of sensors intended to detect the present geometry of a device having a multiple part housing adapted to move relative to one another, in accordance with a further embodiment;

FIG. 4 is a top plan view of a preferred beam forming associated with at least one possible use scenario, where the user is proximate to portions of the device in accordance with at least one common use case; and

FIG. 5 is a flow diagram of a method for providing antenna beamforming, in connection with transmitting a signal, in accordance with at least one embodiment of the present invention.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

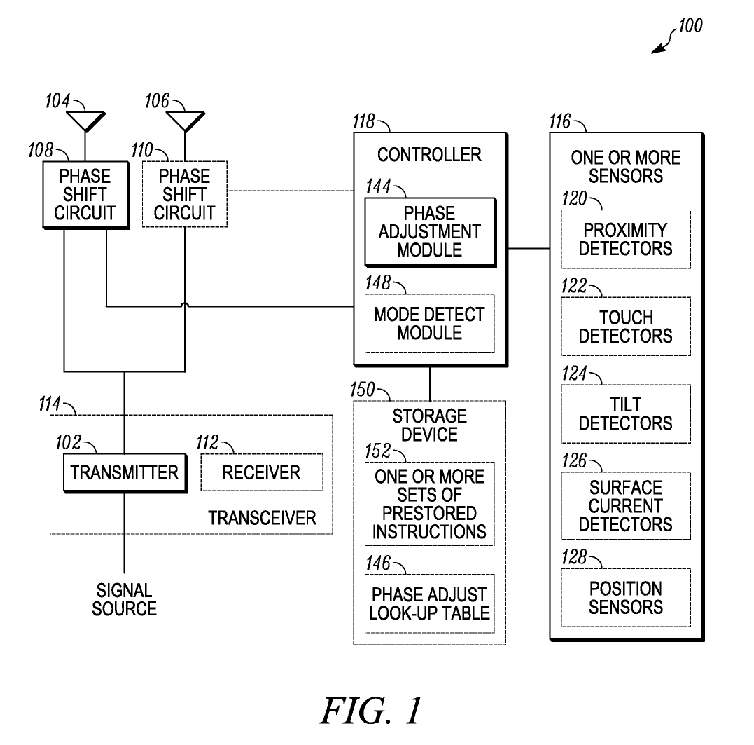

FIG. 1 illustrates a block diagram of wireless communication device 100 for providing antenna beamforming, in connection with transmitting a signal, in accordance with at least one embodiment of the present invention. Beamforming often involves the use of a plurality of antennas, which transmit a similar signal, which in some directions will constructively add, and in other directions will destructively interfere. As such, there are directions of transmissions, which in turn will have varying amounts of transmitted energy, with some directions containing more energy and other areas containing less energy, depending upon the distance of the antennas and the phase relationship of the signal being transmitted at each of the antennas. By altering the phase of the signal supplied to each of the antennas, one can affect, generally rotationally, the direction in which a greater portion of the energy is directed, as well as the direction in which a reduced portion of the energy is directed.

In the wireless communication device 100, illustrated in FIG. 1, the wireless communication device 100 includes a transmitter 102, which is coupled to at least a pair of antennas 104 and 106, each of which is configured to transmit the same sourced signal. The transmitter 102 is coupled to at least one of the two antennas 104 via a phase shift circuit 108, which is adapted to delay the transmission of the signal from one of the antennas relative to the other antenna(s) a planned predetermined amount. In turn, this enables the areas of constructive interference and the areas of destructive interference to be adjusted so as to direct more of the energy in an intended direction. In some instances, it may be beneficial to optionally include a phase shift circuit 110 at the feed point of the other antenna 106. The inclusion of a further phase shift circuit 110 would enable the phase of the signal fed to the second antenna 106 to similarly be separately controlled. Furthermore additional phase shift circuits may be further beneficial in systems incorporating still further additional antennas, so as to be able to control the phase relationship between more than two antennas.

In some instances the same antennas 104 and 106 may be coupled to a receiver 112 for purposes of receiving a remotely transmitted signal. Still further, the transmitter 102 and the receiver 112 might be incorporated as part of a transceiver 114. The inclusion of the receiver 112 might make it possible for the wireless communication device to determine the direction of the intended recipient, when the intended recipient transmits information back to the wireless communication device. In such an instance, the wireless communication device might look at differences in the time of arrival of the signal at each of the two antennas 104 and 106 to receive clues as to the direction of the source of the transmission. Alternatively other forms of analysis on the received signal could also be used to help determine the direction of transmission.

As noted above, it is often not enough to merely direct the energy in a direction toward the intended recipient, but to direct it toward the intended recipient while avoiding other nearby objects which are likely to interfere with the intended propagation of the signal. Wireless communication device 100 includes one or more sensors 116 which are intended to help identify operating characteristics of the device, as well as help identify the presence of other objects, which might be nearby the device. The one or more sensors 116 are coupled to a controller 118, which analyzes the output of the sensors for purposes of identifying the local condition and nearby environment within which the wireless communication device 100 is operating.

Examples of different types of sensors that might be used in identifying the local conditions and/or environment in which the wireless communication device 100 is operating include proximity detectors 120, touch detectors 122, tilt detectors 124, surface current sensors 126, and position sensors 128, which might be positioned at different points in, on or around the device 100. In some instance, some of the sensors might serve dual roles. For example, a touch sensor 122 could both be used to detect the proximity of a nearby object, as well as be used as a form of input used as part of a touch sensitive surface, or a touch sensitive display. By identifying the proximity of the device to potentially nearby objects such as the user's hand or the user's head, the information could be used to steer the transmitted signal around these potential obstructions.

Still further the relative position or orientation of the device, as well as relative location of different parts of the same device, relative to one another, might similarly serve to impact the transmission characteristics of the antennas and in turn may create circumstances in which adjustments in the phase of the signals fed to each of the antennas is desirable. Sensors which might be useful in identifying the relative position or the orientation of the device, as well as the relative location of different parts of the same device, relative to one another, include tilt sensors 124 and position sensors 128.

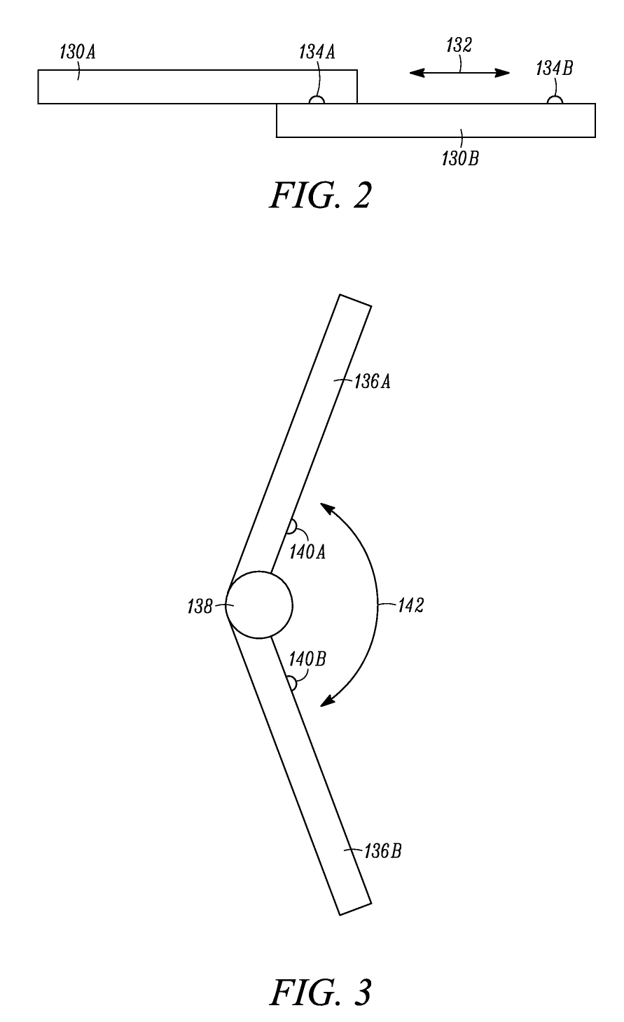

FIGS. 2 and 3 illustrate a side plan views of a pair of different wireless communication devices illustrating exemplary positioning of a set of sensors intended to detect the present geometry of a device having a multiple part housing adapted to move relative to one another. In the case of FIG. 2, the two part housing 130A and 130B are intended to slide relative to one another along a substantially parallel path 132. A pair of sensors 134A and 134B may come into contact or proximity with one another, when the two part housing moves into a predefined position relative to one another. The same is generally true with the wireless communication illustrated in FIG. 3. The difference being the manner in which each part of the two part housing is adapted to move relative to the other. In the exemplary embodiment illustrated in FIG. 3, the two housing portions 136A and 136B rotate 142 relative to one another about a hinge connection 138. Similarly, dependent upon the relative position of the two housing portions 136A and 136B, a pair of sensors 140A and 140B may come into contact or proximity with one another.

The controller 118 is adapted to receive the output values of the various sensors and determine an appropriate phase adjustment. The controller 118 includes a phase adjustment module 144, which is adapted to perform this task. In some instances the phase adjustment module 144 may be capable of directly determining a suitable phase adjustment. In other or the same instances, the phase adjustment module might enlist the aid of a phase adjust look up table 146, which might be included as part of a storage device 150, which has precomputed values, which might be used in determining the appropriate phase adjustments. In some such instances, the phase adjust look up table 146 might include, as part of a default setup, initial precomputed values, which can be later adjusted using one or more adjustment values based upon one or more detected conditions during usage. The detected conditions could come from the outputs of one or more sensors incorporated as part of the device and sensed as part of the operation of the device.

The controller 118 might similarly include a mode detect module 148, which might use information known to the current operating status of the device to help make decisions relative to a suitable phase adjustment. For example, the mode detect module might detect the wireless communication device 100 operating in speaker mode. In such an instance, the device might assume that the device is operating away from the user's ear, and likely away from the user's head.

Furthermore in addition to attempting to maximize the signal received at the intended recipient, the wireless communication device might further attempt to adjust the radiation pattern of the transmitted signal to accommodate other considerations, such as hearing aid compatibility.

The storage device 150 is coupled to the controller. In addition to potentially including one or more phase adjust look up tables 146, the storage device could additionally include one or more sets of pre-stored instructions 152 which may be used in the implementation of one or more of the controller's modules 144 and 148. In such an instance, the controller 118 could be implemented in the form of a microprocessor, which is adapted to execute one or more sets of prestored instructions 152, stored in the storage device 150. While the storage device 150 in the illustrated embodiment is shown separate from the controller 118, in some instances the storage device 150 might be integrated as part of the controller 118. The storage device 150 could include one or more forms of volatile and/or non-volatile memory, including conventional ROM, EPROM, RAM, or EEPROM. The storage device 150 may still further incorporate one or more forms of auxiliary storage, which is either fixed or removable, such as a harddrive, a floppydrive, a secure digital (SD) card, or a transflash card. One skilled in the art will still further appreciate, that still other further forms of memory could be used without departing from the teachings of the present invention. In the same or other instances, the controller 118 may incorporate state machines and/or logic circuitry, which can be used to implement at least partially, some of the modules and their corresponding functionality.

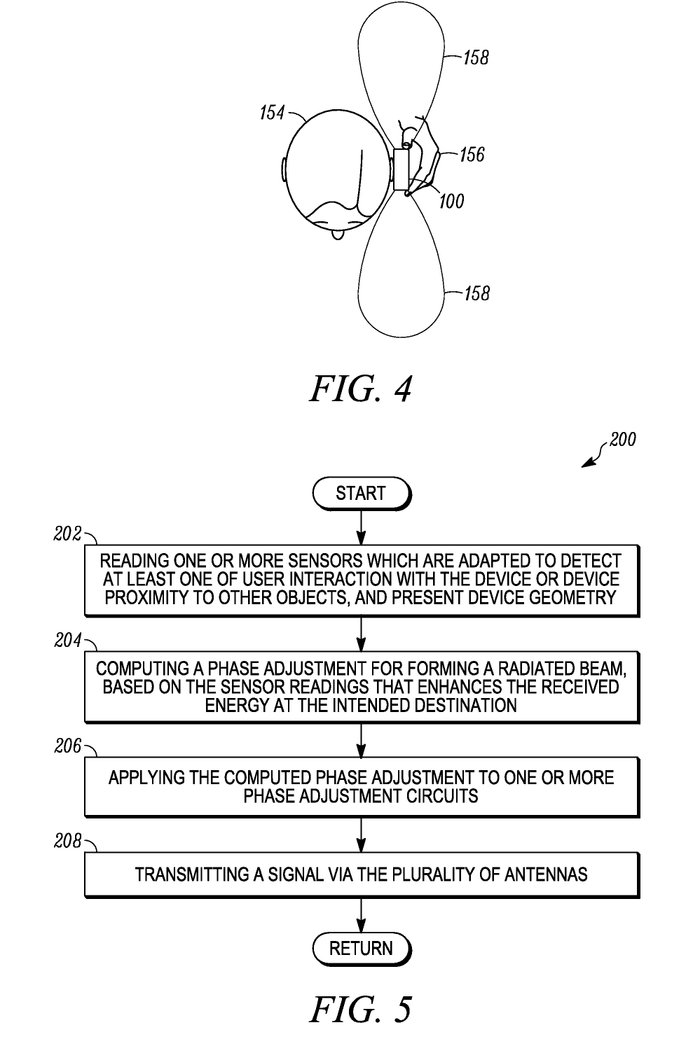

FIG. 4 illustrates a top plan view of a preferred beam forming associated with at least one possible use scenario, where the user's head 154 and hand 156 is proximate to portions of the device 100 in accordance with at least one common use case. In such an instance it may be desirable to steer the beams of radiated energy 158 between the two potentially interfering bodies.

FIG. 5 illustrates a flow diagram 200 of a method for providing antenna beamforming, in connection with transmitting a signal, in accordance with at least one embodiment of the present invention. The method includes reading 202 one or more sensors, which are adapted to detect at least one of user interaction with the device or device proximity to other objects, and present device geometry. A phase adjustment is then computed 204 in a controller for forming a radiated beam, based upon the readings of the one or more sensors, that enhances the received energy at an intended destination. The computed phase adjustment is then applied 206 to one or more phase adjustment circuits, respectively coupled to at least some of the plurality of antennas. A signal is then transmitted 208 by a transmitter to the intended destination via at least some of the plurality of antennas.

In at least some embodiments, the method might further include receiving a signal from the intended destination, and computing the direction of arrival of the signal, wherein the direction of arrival is used by the controller in computing a phase adjustment.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a device having a plurality of antennas for providing beamforming, the method comprising:
reading one or more sensors, which are adapted to detect at least one of user interaction with the device or device proximity to other objects, and present device geometry;
computing a phase adjustment in a controller for forming a radiated beam, based upon the readings of the one or more sensors, that enhances the received energy at an intended destination;
applying the computed phase adjustment to one or more phase adjustment circuits, respectively coupled to at least some of the plurality of antennas;
transmitting by a transmitter via at least some of the plurality of antennas, a signal to the intended destination.

2. A method in accordance with claim 1 further comprising:
receiving a signal from the intended destination, and computing the direction of arrival of the signal, wherein the direction of arrival is used by the controller in computing a phase adjustment.

3. A method in accordance with claim 2 wherein the direction of arrival is determined by detecting a time of arrival difference of a signal received at each of a plurality of the antennas.

4. A method in accordance with claim 2 wherein the direction of arrival is determined by iteratively applying one or more phase adjustments, and observing the change in the received signal strength.

5. A method in accordance with claim 1 further comprising observing the current use characteristics of the device by the controller, wherein the observed use characteristics are used by the controller in computing a phase adjustment.

6. A method in accordance with claim 5 wherein observing the current use characteristics includes observing the present mode of operation.

7. A method in accordance with claim 1 wherein the controller uses at least some of the values upon which the phase adjustment is based to access a look up table stored in memory of the device, in determining at least partially the phase adjustment.

8. A method in accordance with claim 1 wherein the sensors used to determine user interaction with the device or device proximity to other objects include proximity sensors positioned at different points around the exterior surface of the device.

9. A method in accordance with claim 1 wherein the device includes a housing having multiple housing elements that move relative to one another, and wherein the sensors that detect the present device geometry includes sensors that detect the relative movement/position of the multiple housing elements relative to one another.

10. A wireless communication device comprising:
a transmitter for producing a signal to be transmitted;
a plurality of antennas coupled to the transmitter for receiving the signal to be transmitted and converting the signal into radiated energy;
one or more sensors adapted for detecting at least one of user interaction with the device or device proximity to other objects, and present device geometry;
a controller coupled to the plurality of sensors for receiving the detected output of the sensors; and
one or more phase shift circuits coupled between at least one of the antennas and the transmitter, for adjusting the phase of the signal received by the corresponding antenna; and
wherein the controller includes a phase adjustment module adapted to produce a control signal based upon the received output of the sensors, which controls the amount of phase shift applied by the one or more phase shift circuits.

11. A wireless communication device in accordance with claim 10 wherein the one or more sensors include one or more proximity detectors.

12. A wireless communication device in accordance with claim 10 wherein the one or more sensors include one or more touch detectors.

13. A wireless communication device in accordance with claim 10 wherein the one or more sensors include one or more tilt detectors.

14. A wireless communication device in accordance with claim 10 wherein the one or more sensors include one or more surface current detectors.

15. A wireless communication device in accordance with claim 10 wherein the wireless communication device further comprises a housing having multiple housing elements that move relative to one another, and wherein the one or more sensors include sensors that detect the relative movement/position of the multiple housing elements relative to one another.

16. A wireless communication device in accordance with claim 10 further comprising a storage device coupled to the controller.

17. A wireless communication device in accordance with claim 16 wherein the storage device includes one or more sets of prestored instructions for use in implementing the one or more modules of the controller.

18. A wireless communication device in accordance with claim 16 wherein the storage device includes one or more look up tables for use in producing the control signal used to control the amount of the phase shift applied by the one or more phase shift circuits, based upon one or more of the values detected by the sensors.

19. A wireless communication device in accordance with claim 1 wherein the controller includes a mode module adapted for detecting the current operating mode of the device.

20. A wireless communication device in accordance with claim 10 further comprising a receiver adapted for detecting a radiated signal originating from outside of the device and for producing a received signal, wherein detected characteristics of the received signal can be used to identify the direction of an intended destination of signals to be transmitted by the wireless communication device.
